(19) United States
(12) Patent Application Publication
(10) Pub. No.: US 2002/0052777 A1
(43) Pub. Date: May 2, 2002

(54) System and method for complying with affirmative action programs

(76) Inventor: Charles A. Washington, University Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/896,627

(22) Filed: Jun. 29, 2001

Related U.S. Application Data
(60) Provisional application No. 60/215,029, filed on Jun. 29, 2000.

(51) Int. Cl. G06F 17/60

(52) U.S. Cl. 705/11

(57) ABSTRACT

A method and system for setting affirmative action goals for a project, evaluating compliance with those goals while the project is progressing, and modifying behavior to better attain the goals.

### CROSS-REFERENCE TO RELATED APPLICATION

This case is based on Provisional Application Serial No. 60/215,029, filed Jun. 29, 2000, the benefit of which is claimed and the disclosure of which is incorporated herein by reference.

### FIELD AND BACKGROUND OF THE INVENTION

1. Field of the Invention

The present invention generally relates to a method and system for the administration of affirmative action performance. It concerns such a method and system for evaluating and managing compliance with governmental requirements, regulations and performance levels. More specifically the present invention concerns a method and system for evaluating whether agreed-upon affirmative action goals are being met, and then modifying behavior to try either to continue compliance or to reach compliance. Most specifically the present invention concerns such a method for aiding governmental agencies to comply with U.S. Supreme Court rulings concerning affirmative action.

2. Background of the Invention

The administration of governmental affirmative action regulations and requirements has typically been performed by a number of separate government departments, each of which receive information from private sector contractors and suppliers. Information from individual private sector entities concerning their performance and compliance with affirmative action and equal employment requirements and regulations is typically required by governments, including municipalities, government agencies, and governments at all levels of jurisdiction. Such information may be required specifically in connection with the receipt of contract bids, the awarding of contracts and installment payments pursuant to government contracts. This is only one of several regulatory compliance schemes which business and public sector entities contracting to provide goods or services to governments must follow. They also must contend with environmental regulations, employment regulations, and several other regulatory schemes.

Many such laws, enacted as part of government affirmative action initiatives, provide for goals, requirements and monitoring procedures regarding the amount of minority participation in business and public sector agencies contracting with the government. These laws often can be vague, confusing, and hard to understand. Add to that the business's or public sector agency's duty to comply with other governmental regulatory regimes, which can be just as hard to understand, and significant amounts of time are spent just ensuring compliance with all the regulations. Time can more efficiently be spent providing quality goods or services to the government.

Generally speaking, government contracts and associated finds are awarded to “recipients” who agree to oversee completion of a project. To complete the project, the recipient typically hires other “contractors” to perform sub-projects which, when they all are finished, complete the project as a whole. Affirmative action guidelines and regulations can apply not only to the overall project as a whole, but also to the sub-projects.

In many instances one entity might be both a recipient and a contractor; the relevant project determines into which category the entity falls. As an illustrative example, one recipient might be a state agency receiving funds from the federal government to maintain federal highways within the state. The state agency, in turn, hires different contractors to complete defined tasks such as adding a lane to a portion of a particular highway. From the state agency's perspective as a recipient of federal funds, the project is maintaining highways and a sub-project is adding a lane. From the perspective of the contractor hired to add the lane, though, the project is adding a lane while the sub-projects include hiring other contractors to perform more specific tasks, such as laying down concrete and installing guardrails. The state agency and the contractor are both recipients and must potentially comply with the federal government's affirmative action rules and guidelines, but the relevant project and sub-projects differ for each.

Affirmative action guidelines appear as part of several government regulations: small business aid regulations, equal employment opportunity regulations, and on the job training regulations are just a few examples. One set of affirmative action rules and guidelines has been codified by the United States Department of Transportation (“DOT”) in the Code of Federal Regulations, Title 49, Part 26, entitled: “Participation by Disadvantaged Business Enterprises in Department of Transportation Financial Assistance Programs.” These regulations were enacted to remedy past and current discrimination against disadvantaged business enterprises (“DBE's”), ensure a level playing field, foster equal opportunity in DOT assisted contracts, and reduce burdens on small businesses. They strive to meet these goals by providing financial assistance to recipients of DOT contracts, concerning for example the building and maintenance of highways and bridges. Such recipients may include public sector agencies as well as private building contractors. In return for the financial assistance, recipients agree to strive toward awarding a certain percentage of the subcontracting work under the contract to DBE's. This specification generically refers to businesses entitled to benefit under affirmative action programs as “DBE's.” Other government affirmative action programs may use different labels to refer to such businesses.

In part due to vagueness in its regulations, the DOT amended its rules effective March 1999. One significant change which then took place is the time at which regulatory compliance is measured. Before the amendments, only the acceptance of bids was examined so that a recipient complied with the law if it merely accepted a sufficient amount of bids from DBE's. Now, for projects started after the amendments, the government tracks money actually paid to DBE's for work preformed on the project, rather than just examining accepting bids. For projects started before the amendments the old rules continue to apply. The amendments are conceptually equivalent to changing from an accrual accounting method (recognizing income and expense at the time they are incurred) to a cash accounting method (recognizing income and expense at the time they are paid).

Thus, under the new law, as the project progresses recipients must keep track of money actually paid to DBE's to see whether affirmative action goals are being met. Projects may last many years, making monitoring difficult and expensive. And, if the goals are not being met, the recipient must decide how to change its behavior to meet the goals most economically. This procedure is complicated by the fact that many DBE's perform “close-out” jobs at the end of a multi-year project: erecting guard rails, landscaping, stripping, and similar tasks. Thus, early in the project DBE participation might be extremely low, but then be extremely high (relatively speaking) at the end.

For the foregoing reasons there is a need for a method and system allowing recipients and contractors to monitor actual use of DBE's when performing a project. There also is needed a method and system to evaluate compliance with affirmative action goals set at the beginning of a project. It also is desirable to modify subsequent behavior to reflect intervening events affecting such compliance. The present inventive method and system solves these problems.

### SUMMARY OF THE INVENTION

According to one embodiment of the present invention, a method of tracking compliance with affirmative action goals during a project is provided, the method comprising the steps of setting goals at the beginning of the project, monitoring actual affirmative action performance and the relevant marketplaces as the project progresses, and modifying the initially set goals and future behavior to better reflect the relevant marketplaces.

The present invention allows recipients to set up affirmative action goals which are realistically obtainable under constraints set by the U.S. Supreme Court. It permits monitoring compliance with affirmative action goals as the project is ongoing, and modify future behavior to better attain realistic goals. These and other advantages of the present invention will become more apparent from a detailed description of the invention.

### BRIEF DESCRIPTION OF THE DRAWINGS

In the accompanying drawings, which are incorporated in and constitute a part of this specification, embodiments of the invention are illustrated. These drawings, together with the general description of the invention given above and the detailed description given below, serve to example the principles of this invention.

FIG. 1 is a schematic flow chart depicting an overall system in accordance with the present invention.

FIG. 2 is a schematic flow chart depicting an exemplary evaluation and correction step in the system of FIG. 1.

FIG. 3 is a graph illustrating recalculation of the RC component of the project overall goal as the project continues.

### DETAILED DESCRIPTION OF THE PREFERRED EMBODIMENT

The present invention is a system and method for the administration of affirmative action performance, pursuant to which a recipient may monitor how well it is achieving set goals concerning the use of DBE's in the performance of a contract and modify future behavior to better attain those goals.

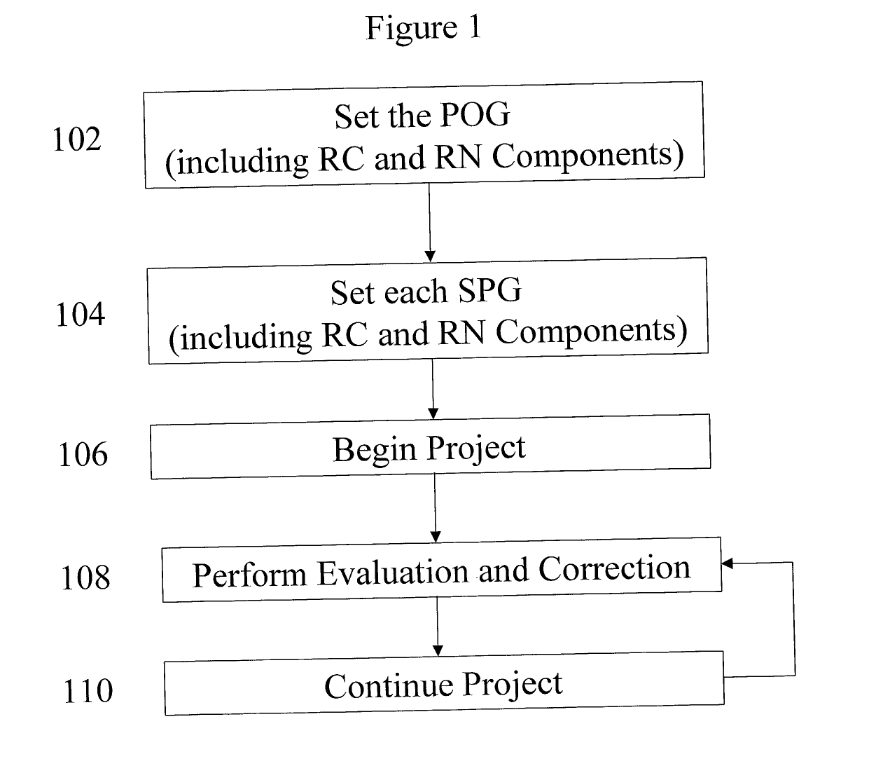

FIG. 1 illustrates an exemplary overall system diagram in accordance with the present invention. At the beginning of the project a project overall goal (“POG”) for the hiring of DBE's is set 102. The POG is the amount of money to be awarded DBE's for the project as a whole over some initial time period (time periods are discussed in more detail below). It may conveniently be expressed as a percentage of the total amount of money to be spent on the project during the initial time period. For example, if a total of 1 million dollars is to be spent on the project during the first time period, and $200,000 should be awarded to DBE's, then the POG may alternatively be expressed as $200,000 or twenty percent (20%). The initial POG may be set unilaterally by the government, unilaterally by the recipient, or mutually agreed upon by both contracting parties. The POG is divided into a race conscious (“RC”) component and a race neutral (“RN”) component. The RC component consists of money paid by the recipient to contractors pursuant to contracts which set a goal for an amount (or percentage) of money the contractor will allocate to DBE's to complete the contractor's sub-project. The RN component consists of money paid by the recipient to contractors pursuant to contracts which set no such goals, so that the contractor is left absolutely free to allocate money without considering whether the payee is a DBE.

One convenient (but not exclusive) way to choose an initial and realistically attainable POG is to compile a database of qualified contractors which the recipient might hire to help complete the project. Factors such as contractor location, capacity, and certification may determine whether a particular contractor is qualified. As to location, appropriate geographical limits must be set after considering the needs of the project. If a project or a sub-project is very highly specialized, it might be appropriate to include all contractors in the United States or even the world for that project or sub-project. For more normal tasks, it may be sufficient to include only contractors in the recipient's country, state or county.

As to contractor capacity, several items should be considered. Key variables include the contractor's gross annual receipts for the prior year or other appropriate accounting period; the average size of sub-projects in the project on which the contractor might work; the total value of the contractor's on-going contracts; the contractor's bonding limit; and the number of employees working for the contractor. A contractor might not have enough capacity, for example, if (1) the value of its on-going contracts exceeds its bonding limit, or (2) the value of its on-going contracts exceeds the contractor's gross annual receipts for the prior year and the contractor might not be able to fit the sub-project into its current schedule. Whatever capacity thresholds are set by the recipient, it is important that they be uniformly applied to DBE's and non-DBE's.

Once all qualified contractors have been added to the contractor database, including all relevant information known about each contractor, the initial POG may be set using that database. The POG is set as a percentage calculated by dividing the number of all qualified contractors which are DBE's by the number of all qualified contractors, and multiplying by 100. If desired, the recipient may increase that result by an amount sufficient to compensate for the fact that, but for prior illegal discrimination, more DBE's would be available. For reasons more fully described below, after calculating the initial POG the recipient should make every effort to keep its database of qualified contractors complete with all information in it accurate.

For each sub-project of the recipient's project, a sub-project goal (“SPG”) is established 104. Similar to the POG, the SPG is the amount of money to be awarded to DBE's for the sub-project as a whole. It may conveniently be expressed as a percentage of the total amount of money to be spent on the sub-project. If expressed as a percentage, each SPG may or may not equal the POG. For example, if many DBE's may be found in a particular area of industry, the SPG for the sub-project to be completed by that industry can be higher than the SPG for other sub-projects, and in the aggregate the project will still attain the POG. Each SPG may initially be set unilaterally by the government, unilaterally by the recipient, or mutually agreed upon by both contracting parties. Like the POG, the SPG is divided into RC and RN components.

One convenient way to set initial SPG values is to compile a list of “SIC” codes, “NAICS” codes, or “NIGP” codes to be used on the sub-project. SIC stands for the U.S. Standard Industrial Classification. NAICS stands for the North American Industrial Classification System. NIGP stands for the National Institute of Governmental Purchasing. Each scheme assigns a unique number to a particular area of industry: the SIC uses 4 digit codes, the NAICS uses 6 digit codes, and the NIGP uses 7 digit codes. The SIC is widely available, including as part of the book NAICS/SIC Code United States Manual 1997 (2d ed., Claitor's Publishing Division, 1997), incorporated herein by reference. The NAICS is also widely available and is published by the United States government in book and CD-ROM form entitled North American Industrial Classification (United States 1997), and that publication is incorporated herein by reference. The NIGP classification system is available from NIGP, and is incorporating herein by reference. These and other, similar classification systems are herein referred to as: “industry classification.”

The recipient then compares the industry classification codes for the sub-project with a list of qualified contractors which the recipient could realistically hire to help complete the sub-project over the initial time period. This list is compiled in the same way as for calculating the POG, but the recipient must additionally keep track of each contractor's industry classification codes in addition to DBE status and the other variables. The SPG is then set as a percentage calculated by dividing the number of all DBE qualified contractors falling under an appropriate industry classification code for the relevant sub-project by the number of all qualified contractors falling under such an appropriate industry classification code, and multiplying by 100. If desired, that result may be increased by an amount sufficient to compensate for the fact that, but for prior illegal discrimination, more DBE's would be available. For reasons more fully described below, after calculating the SPG the recipient should make every effort to keep its list of qualified contractors complete and accurate, including all applicable industry classification codes.

The RC and RN components for the sub-project preferably, but not necessarily, respectively comprise the same proportion of the SPG as the RC and RN components of the POG comprise of the POG. This is done using the following formula:

$${RC}_{SPG} = \frac{( {RC}_{POG} ) ( SPG )}{POG} \qquad \text{(Formula 1)}$$

Here RC_{SPG} represents the RC component of the SPG, and RC_{POG} represents the RC component of the POG. The initial RN component of the SPG is calculated in an analogous manner, replacing all occurrences of RC in the formula above with RN.

Once initial values have been set for the POG, including its RC and RN components, and the SPG, including its RC and RN components, the recipient may then begin awarding contracts to contractors to complete sub-projects 106. If a contractor has agreed to enter into a race conscious contract, and the contractor is itself a DBE, any money it retains as its profit on the sub-project can count toward the contractor's commitment. As indicated below, both the POG and each contractor's SPG may change due to developing circumstances in the marketplace affecting the number of qualified DBE's. The recipient should, however, keep a record of the initial values if required by the particular government regulations at issue. Subsequent monitoring then allows the recipient to evaluate how its affirmative action plan is proceeding.

The sub-projects may not all start or end at once. Often one sub-project must be completed before another can begin. After contracts have been awarded to contractors for sub-projects beginning at the start of the project, the recipient should begin to monitor spending to see whether it remains on track to meet the POG and each SPG. In this regard each project has a “lifetime.” The project lifetime begins as soon as the recipient allocates money to one or more sub-projects, and continues so long as any sub-project remains uncompleted. Thus, the expected lifetime of the project may change as the project progresses.

For tracking and evaluation purposes the recipient breaks up the project lifetime into a series of discrete time periods. The chosen time period should be frequent enough to provide sufficient feedback, without being so frequent as to require too much time to administer. For a project expected to last five or more years, a yearly time period might be sufficient. For a project expected to last only a few years, a quarterly time period might be sufficient. Some times even daily monitoring might be advisable.

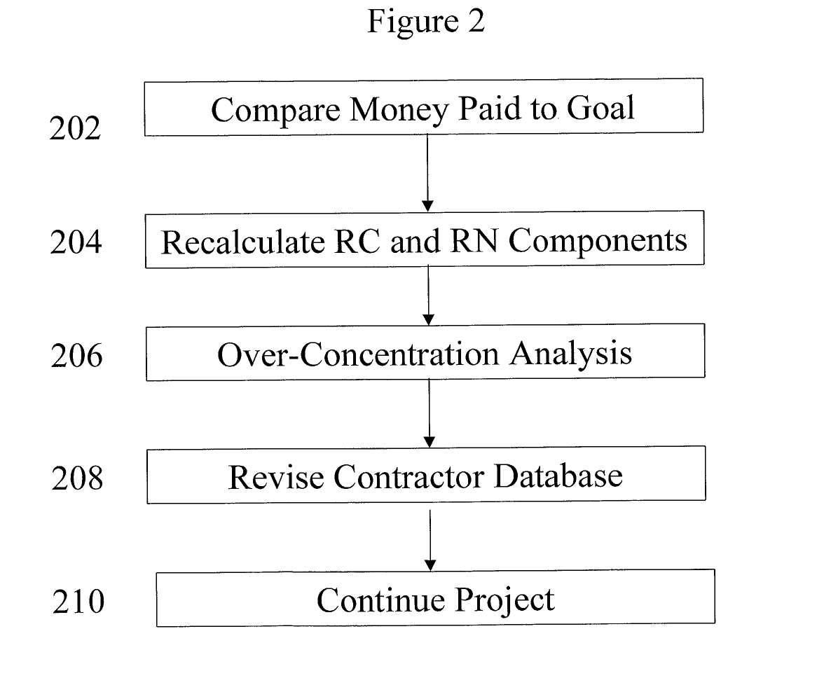

For each time period the recipient tracks all money actually spent on the project, whether by the recipient or a contractor, including whether the money is paid to a DBE or a non-DBE. At the end of each time period the recipient performs an evaluation and correction procedure 108. This procedure is illustrated in FIG. 2. Pursuant to that procedure, the money actually paid to DBE's project-wide is compared with the POG 202. Similarly, the money actually paid to DBE's for each sub-project is compared to the SPG for that sub-project 202. If the money actually paid to DBE's for the project is less than the POG, the RC component of the POG is increased. Similarly, if the money actually paid to DBE's for the project is more than the POG, the RC component of the POG is decreased (and perhaps set to zero). An equivalent evaluation and correction is performed at the same time for each sub-project's SPG and each sub-project's RC component.

First the recipient should evaluate whether to change the RC component of the POG, and if so by how much 204. There are several potential methodologies for performing this step. One way is to calculate the following formula:

$${U}_{RC / POG} = ( \frac{{Budget}_{DBE}}{{Budget}_{PROJECT}} ) ( \frac{{Spent}_{DBE}}{{Spent}_{PROJECT}} ) ( {\overline{RC}}_{POG} ) \qquad \text{(Formula 2)}$$

Here U_{RC/POG} represents the “utilization” of DBE's in the entire project due to race conscious efforts; Budget_{DBE} represents the number of dollars budgeted to DBE's in the project for the prior period; Budget_{PROJECT} represents the number of dollars budgeted to the entire project for the prior period; Spent_{DBE} represents the number of dollars actually paid to DBE's in the project for the prior period; Spent_{PROJECT} represents the number of dollars actually paid as part of the project for the prior period; and \overline{RC}_{POG} represents the average RC component of the POG for all prior time periods. It also is helpful to calculate a similar quantity U_{RN/POG} with respect to the RN component of the POG, by using dollar amounts budgeted and spent only on that sub-project and replacing \overline{RC}_{POG} in Formula 2 with \overline{RN}_{POG}, the average RN component of the POG for all prior time periods.

The value of U_{RC} may determine whether to change the RC component of the POG or SPG for the next time period. Ideally U_{RC} equals 1.0, because that means the recipient is using DBE's in a manner proportionate to their presence in the marketplace. If U_{RC} is substantially greater than 1.0 then DBE's are being over-utilized in relation to their presence in the marketplace, indicating the RC component of the POG or SPG should be decreased or even set to zero. If U_{RC} is substantially less than 1.0 then DBE's are being under-utilized in relation to their presence in the marketplace, indicating the RC component of the POG or SPG should be increased.

The recipient may if desirable set more definite rules as to when it will change the RC component of the POG. Any such set of rules should be tailored to the recipient's specific situation, considering the relevant marketplaces and the needs of the project. One such approach would be to set the RC component of the POG or SPG to zero for the next time period (with a concomitant increase in the RN component) if U_{RC} is substantially greater than 1.0, decrease the relative value of the RC component of the POG or SPG if U_{RC} is slightly greater than 1.0, keep the relative value of the RC component at the same proportion of the POG or SPG as in the previous year if U_{RC} is about equal to 1.0, and increase the relative value of the RC component if U_{RC} is less than about 1.0.

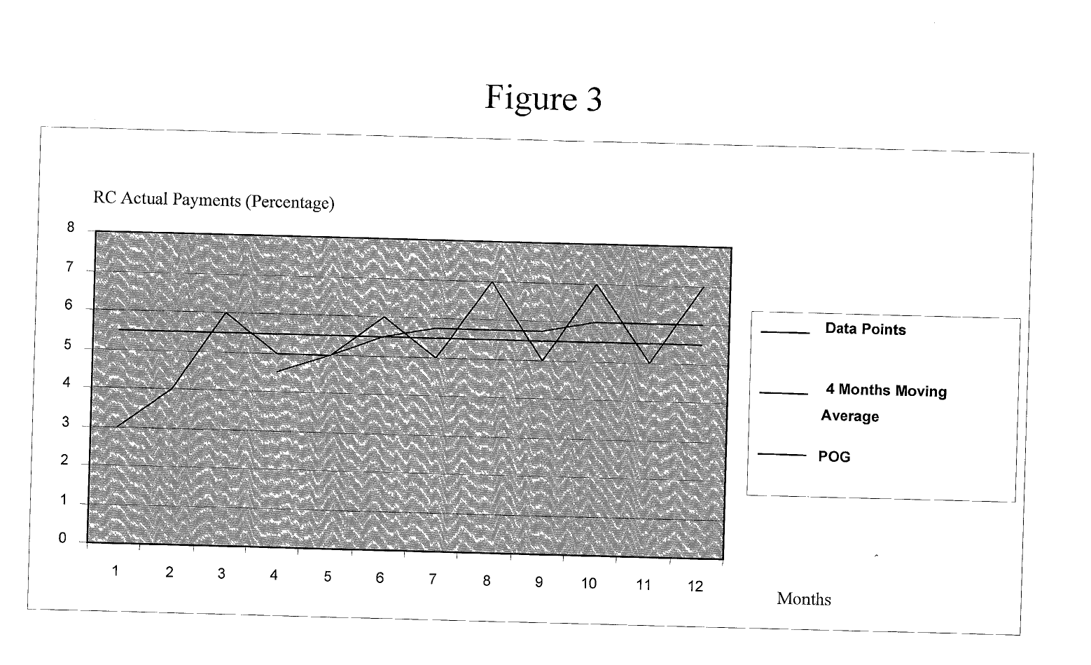

The inventor has found the following procedure to be useful in this regard. First the recipient tracks the amount of money actually paid to DBE's during appropriately set sub-periods during the previous time period. For example, if the time period is one year, the recipient might track such amounts by month (illustrated in FIG. 3); if the time period is 6 months, the recipient might track such amounts on a bi-weekly basis. The recipient then calculates the moving average of money actually paid to DBE's during the sub-periods, where the average for a given sub-period equals the average of the amount of money paid to DBE's during the previous few sub-periods. The chosen number of sub-periods must be at least two, and more preferably is at least four. FIG. 3 illustrates moving average calculations for a time period of 1 year, a sub-period of one month, and a moving average sub-period of four months.

Then the following formula is applied to set the RC component of the POG for the upcoming year:

$${RC}_{POG} = \{ \begin{matrix}{MA}_{FINAL} > {POG}_{i - 1} ⇒ \frac{( {POG}_{i} ) ( {RC}_{i - 1} )}{{POG}_{i - 1}} + ( \overline{MA} - {POG}_{i - 1} ) \\ {MA}_{FINAL} \approx {POG}_{i - 1} ⇒ \frac{( {POG}_{i} ) ( {RC}_{i - 1} )}{{POG}_{i - 1}} \\ {MA}_{FINAL} < {POG}_{i - 1} ⇒ \frac{( {POG}_{i} ) ( {RC}_{i - 1} )}{{POG}_{i - 1}} + ( {POG}_{i - 1} - \overline{MA} )\end{matrix} \} \qquad \text{(Formula 3)}$$

In these equations RC_{POG} represents the RC component of the POG for the upcoming year; MA_{FINAL} represents the moving average calculated for the last sub-period in the previous time period; POGᵢ₋₁ represents the POG of the previous year; POGᵢ represents the POG for the upcoming year; RCᵢ₋₁ represents the RC component of the POG for the previous year; and \overline{MA} represents the average of the moving averages of all sub-periods for the previous year. The RN component of the POG for the upcoming year is calculated in an analogous manner, replacing all occurrences of RC in the equations above with RN.

The RC and RN components of each SPG for the upcoming time period may conveniently then be set as the same proportion of the SPG, respectively, as the calculated RC and RN components of the POG. In other words, Formula 1 may be used inserting the values for RC_{POG} or RN_{POG}, POG and SPG already calculated for the upcoming time period.

The evaluation and correction procedure 108 next involves an over-concentration analysis 206. This analysis is performed for each industrial classification code. The following formula is calculated:

$${U}_{INDUSTRY} = \frac{( \frac{{Spent}_{DBE}}{{Spent}_{INDUSTRY}} )}{( \frac{{N}_{DBE}}{{N}_{INDUSTRY}} )} . \qquad \text{(Formula 4)}$$

Here U_{INDUSTRY} represents the “utilization” of DBE's in a particular industry classification; Spent_{DBE} represents the number of dollars actually paid to DBE's falling in the industry classification; Spent_{PROJECT} represents the number of dollars actually paid to any contractor falling in the industry classification; N_{DBE} represents the number of DBE's in the industry classification; and N_{CONTRACTORS} represents the number of contractors in the industry classification.

Similar to the calculation of U_{RC}, U_{INDUSTRY} may help the recipient determine whether to continue race conscious hiring efforts in the industry classification of interest. If U_{INDUSTRY} is greater than or about equal to 1.0, then the recipient should not enter into any race conscious contracts with contractors in the industry classification of interest. If U_{INDUSTRY} is less than 1.0, then the recipient should continue entering race conscious contracts with contractors in the industry classification of interest. Agreements already in force are not changed; race conscious agreements remain race conscious, .race neutral agreements remain race neutral.

The evaluation and correction procedure 108 also may involve an investigation into the market availability of qualified contractors 208. Contractors on the recipient's list which no longer meet the minimum qualifications for the project should be removed from the list. New contractors, and old contractors which have changed their operations, should be investigated to determine whether they meet the recipient's minimum qualifications and so should be added to, kept on or removed from the recipient's qualified contractor list.

Once the list of contractors is updated, the recipient should ensure its information regarding each contractor remains accurate. If the amount of DBE's qualified for the project has decreased, the POG and/or relevant SPG's should be concomitantly decreased. The converse is true if the amount of DBE's which might be suitable for the project has increased. Conveniently (but not necessarily) the POG may be set as a percentage calculated by dividing the number of all DBE qualified contractors (as updated by the recipient) by the number of all qualified contractors (as updated by the recipient), and multiplying by 100. If desired, the recipient may increase that result by an amount sufficient to compensate for the fact that, but for prior illegal discrimination, more DBE's would be available. The same calculation applies to SPG's, using only those contractors qualified to work on the sub-project. This portion of the evaluation and correction procedure 108 ensures affirmative action goals do not exceed realistic expectations given the amount of DBE's actually present in the marketplace. To do this adequately, however, the recipient must ensure its lists of qualified contractors remains comprehensive and up to date.

The described method and system may be embodied as software stored on a computer readable medium including instructions executable by a computer system. Such a computer system comprises a computer memory device for entering and storing needed information, such as data relating to contractor qualifications. It further comprises a processing device for performing the compilation, evaluation and analysis of the data as set forth above. It preferably also comprises an output device for generating reports and correspondence concerning how well affirmative action goals are being met. These tasks may be implemented in any known programming language such as PERL, C++, or others. The inventor has chosen to use Powerbuilder. The computer system generally may take many forms, from a configuration including a variety of processing units, networked together to function as a integral entity, to a single computer, e.g., a personal computer, operational in a stand-alone environment. The computer system may also be a network server servicing remote users, such as through the Internet. The present invention can be embodied in any of these computer system configurations.

The inventor commercializes the present invention as a suite of software products sold under the trademark CHAMP. CHAMP automates the federal, state and local governments' Equal Employment Opportunity (“EEO”)/Affirmative Action compliance requirements. The CHAMP software suite consists of three components: one for government agencies and two for government contractors. The contractors' components enable users to electronically track, monitor and send EEO reports to contracting agencies. The agencies' component receives the EEO reports and analyzes the information. The functions and analyses within CHAMP software products are designed to comply with current case law and the new DOT regulations.

While a preferred embodiment of the invention has been disclosed in detail, the present invention is not to be considered limited to the precise modules and module arrangements disclosed herein. Various adaptations, modifications and uses of the invention may occur to those skilled in the art to which the invention relates, and the invention is to cover all such adaptations, modifications and uses falling within the spirit and scope of the following claims. While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

I claim:

1. A method of tracking compliance with affirmative action goals during a project, where the project includes a set of sub-projects, the method comprising the steps of setting a project overall goal, setting a sub-project goal for each sub-project, setting race conscious and race neutral components of the project overall goal, setting race conscious and race neutral components for each of the sub-project goals, monitoring actual affirmative action performance as the project progresses, monitoring relevant marketplaces, and modifying the race conscious and race neutral components of the project overall goal and each sub-project goal to better reflect the relevant marketplaces.
